(19) United States
(12) Patent Application Publication
(10) Pub. No.: US 2004/0238801 A1
(43) Pub. Date: Dec. 2, 2004

(54) Light-diffusing film and composition for the same

(76) Inventors: Cheol-Heung Ahn, Cheonan (KR); Chi Yook Moon, Cheonan (KR)

Correspondence Address: NIXON & VANDERHYE, PC, 1100 N GLEBE ROAD, 8TH FLOOR, ARLINGTON, VA, 22201-4714, US

(21) Appl. No.: 10/480,446

(22) PCT Filed: Jun. 14, 2001
(86) PCT No.: PCT/KR01/01024

(51) Int. Cl. G02B 5/02

(52) U.S. Cl. 252/582

(57) ABSTRACT

Provided are a composition for a light diffusing film having an excellent luminance characteristics and high luminance uniformity while producing no electrostatic spots, and a light diffusing film using the composition. The composition includes 100 parts by weight of a binder resin, 10 to 500 parts by weight of a light diffuser and 30 to 500 parts by weight of an organic solvent and has a volume resistance of 1×10¹³ 106 cm or less. Since the light diffusing film obtained from the composition has a volume resistance of 1×10¹³ 106 cm or less, electrostatic spots were not generated, while exhibiting good luminance and high luminance uniformity.

### TECHNICAL FIELD

The present invention relates to a composition for a light diffusing film and a light diffusing film using the composition, and more particularly, to a composition for a light diffusing film, which has a clean appearance without electrostatic spots and which has excellent luminance characteristics and uniformity to be suitably used in a variety of kinds of picture display devices.

### BACKGROUND ART

In industry, polymeric resin films have a wide variety of applications including bases for packing, photographic films, condensers, electric insulators, labels, magnetic recording media, medical purposes. In recent years, polymeric resin films have also been in widespread use as base materials for picture display devices such as rear projection type screens, plasma display panels or liquid crystal display devices.

In particular, unlike a cathode ray tube, a picture display device is based on an indirect illuminating method in which a picture is displayed through a light guiding plate by allowing light generated from a phosphor tube of a backlighting unit adhered to a rear surface of the device to be reflected to a metal deposition layer or white plate, so that the picture is not clearly visible, which is getting severer in accordance with the tendency of larger picture display devices.

To overcome the above-described problem, there has been developed a light diffusing film which can increase luminance by adhering the same to a light guiding plate to uniformly diffuse light. For example, Japanese Patent Laid-open Publication Nos. 6-67003, 7-174909 and 9-127314 disclose light diffusing films coated with a solution prepared by diffusing inorganic or organic particles as a light diffuser in an organic solvent with a transparent binder resin, on one surface of a transparent polymeric resin film.

However, the thus-formed light diffusing films have problems of unsatisfactory optical properties or low luminance uniformity throughout the entire surface of the film.

In order to satisfy the uniformity in luminance, it is important to sufficiently diffuse an organic or inorganic light diffuser into a light diffusing layer. However, even if a well-diffused composition is coated on a base film, the uniformity in luminance cannot be satisfied by non-uniform light diffusing layer.

In particular, since a polymeric resin used as a base film has high electric resistance, uniform coating is difficult to achieve. Also, when a light diffusing layer coated with the polymeric resin is dried, coating irregularities shaped of a bird's foot or ellipse, which are also called electrostatic spots, are generated on the surface of the light diffusing layer, thereby resulting in bad appearance and deteriorated luminance and lower luminance uniformity.

### DISCLOSURE OF THE INVENTION

To solve the above-described problems, it is an object of the present invention to provide a composition for a light diffusing film having an excellent luminance characteristics and high luminance uniformity while producing no electrostatic spots.

It is another object of the present invention to provide a light diffusing film obtained by coating the composition.

It is still another object of the present invention to provide a backlight for a liquid crystal display (LCD) or a lamp for a light emitting diode (LED).

To accomplish the above object, there is provided a composition for a light diffusing film, the composition including 100 parts by weight of a binder resin, 10 to 500 parts by weight of a light diffuser and 30 to 500 parts by weight of an organic solvent and having a volume resistance of 1×10¹³ Ωcm or less.

The volume resistance of the organic solvent is preferably 1×10¹³ Ωcm or less.

Examples of the organic solvent include at least one selected from the group consisting of toluene, dichlorethane, methylethylketone (MEK), methylisobutylketone, cyclohexanone, ethylacetate, n-butylacetate, xylene, cyclohexane, tetrahydrofuran, n-heptane and cellusolvacetate.

As the binder resin used for the composition, any binder resin that is generally used for manufacturing a light diffusing film can be used without limitation, but examples thereof includes polyvinylalcohol, ethylene vinyl copolymer, acryl-based resin, polyester-based resin, styrene-based resin, alkyd-based resin, amino-based resin, polyurethane-based resin and epoxy-based resin.

The light diffuser may be either an inorganic or organic light diffuser, and the light diffuser may be used in single or in a mixed form. Examples of the inorganic light diffuser include silica, zirconia, calcium carbonate, barium sulfonate and titanium oxide. Examples of the organic light diffuser include a homopolymer or copolymer obtained from propylene, vinylidene chloride, acrylonitrile, methyl(meth)acrylate, styrene and urethane.

The composition may further include each 0.1 to 10 parts by weight of a curing agent, a static electricity resisting agent, a leveling agent and a wetting agent, based on 100 parts by weight of the binder resin.

In another aspect of the present invention, there is provided a light diffusing film obtained by coating the above escribed composition.

In still another aspect of the present invention, there is provided a liquid crystal display device (LCD) backlighting system employing the light diffusing film according to the present invention.

### BEAT MODE FOR CARRYING OUT THE INVENTION

The present invention will now be described in more detail.

In general, uniformly forming a light diffusing layer on a base film is associated with several processing parameters. In particular, a light diffuser and a binder resin consisting of organic polymers having volume resistance of greater than or equal to 1×10¹³ Ωcm may generate static electricity between the composition and the base film in the course of performing coating, leading to generation of electrostatic spots on the surface of the light diffusing film, thereby resulting in poor appearance after the light diffusing film is dried, lowering luminance, and noticeably deteriorating luminance uniformity.

Since such electrostatic spots are generated when or after coating the composition containing an organic solvent on the base film, followed by drying, they control the overall volume resistance of the light diffusing composition, so that generation of electrostatic spots can be greatly suppressed.

The present inventors confirmed that electrostatic spots were generally produced when the volume resistance of the light diffusing composition exceeded 1×10¹³ Ωcm. Thus, it is critically important to control the volume resistance of the light diffusing composition to be less than 1×10¹³ Ωcm.

In the present invention, the volume resistance of the light diffusing composition can be controlled to be less than or equal to 1×10¹³ Ωcm by using an organic solvent having a volume resistance of less than or equal to 5×10¹² Ωcm. If the volume resistance of the organic solvent is greater than 5×10¹² Ωcm, the volume resistance of the light diffusing composition may exceed 1×10¹³ Ωcm, thereby undesirably producing electrostatic spots.

Examples of the organic solvent having a volume resistance of less than or equal to 5×10¹² Ωcm include at least one selected from the group consisting of toluene, dichlorethane, methylethylketone (MEK), methylisobutylketone, cyclohexanone, ethylacetate, n-butylacetate, xylene, cyclohexane, tetrahydrofuran, n-heptane and cellusolvacetate, preferably, a mixed solvent of toluene and MEK, a mixed solvent of toluene and cyclohexanone or n-butylacetate. Volume resistance values of these solvents are listed in Table 1, and desirable volume resistance, i.e., less than or equal to 5×10¹² Ωcm, can be reached singly or in mixtures of two or more kinds of these materials.

TABLE 1

| Solvent | Volume resistance (Ωcm) |
|---|---|
| Toluene | 1.29 × 10¹³ |
| Dichloroethane | 4.35 × 10¹¹ |
| Methylethylketone (MEK) | 3.70 × 10⁸ |
| Methylisobutylketone | 3.09 × 10⁸ |
| Cyclohexanone | 1.49 × 10⁸ |
| Ethylacetate | 2.41 × 10¹⁰ |
| n-butylacetate | 2.08 × 10¹⁰ |
| Xylene | 1.45 × 10¹⁴ |
| Cyclohexane | 7.90 × 10¹³ |
| Tetrahydrofuran | 1.60 × 10⁹ |
| n-heptane | 7.93 × 10¹² |
| Cellusolvacetate | 2.38 × 10⁸ |
| MEK:Toluene (1:1) | 1.06 × 10⁹ |
| Toluene:Cyclohexanone (10:1) | 8.28 × 10¹¹ |
| Toluene:Cyclohexanone (10:2) | 1.11 × 10¹¹ |
| Toluene:Cyclohexanone (10:3) | 2.38 × 10¹⁰ |
| Toluene:Cyclohexanone (10:5) | 3.41 × 10⁹ |

When only volume resistance is taken into consideration, MEK, methylisobutylketone, n-butylacetate, cyclohexanone and cellusolvacetate, having a volume resistance of not greater than 5×10¹² Ωcm, can be used without restriction because they do not generate static electricity even if they are used as a solvent for a light diffusing film in single. However, in consideration of coating properties including volatility, solubility, dispersibility, levelling property and so on, it is preferable for the above-noted solvent to be used in combination with other solvent.

The use of toluene, cyclohexane or n-heptane having a volume resistance of greater than 5×10¹³ Ωcm, in single, even if they are relatively cheaper and has better solubility than other solvents, may produce electrostatic spots, but the use thereof in combination with other solvent, such as MEK or cyclohexanone, reduces a volume resistance to 5×10¹² Ωcm or less, thereby allowing toluene, cyclohexane or n-heptane to be used as the organic solvent of the present invention.

A process for making a light diffusing film using the composition of the present invention can be performed by common film manufacturing methods. First, a binder resin solution obtained by homogenously dispersing a light diffuser, a binder resin and a trace of additive in a single or mixed solvent having a volume resistance to 5×10¹² Ωcm or less, is coated on a base film, preferably a polyethylene terephthalate (PET) film, and dried, thereby forming a light diffusing film.

Methods of coating a light diffusing composition on a base film include methods generally known in the art without limitation, and usable coating methods include air knife coating, gravure coating, reverse roll coating, spray coating and blade coating according to material and configuration of the base film.

After the base film is coated with the light diffusing composition, the resultant structure is heated by hot air, infrared rays or far infrared rays, thereby forming a coating layer.

The present invention will now be described more fully with reference to the following examples. The invention may, however, be embodied in different forms and should not be construed as limited to the examples set forth herein. Rather, these examples are provided so that this disclosure will be thorough and complete, and will fully convey the scope of the invention to those skilled in the art.

### EXAMPLE 1

A light diffusing composition having a volume resistance of 4×10⁹ Ωcm prepared by dissolving a binder and a curing agent in a solvent at the following amounts, followed by adding a light diffuser to be dispersed with stirring, was used to manufacture a light diffusing film. Occurrence of electrostatic spots on the surface of the light diffusing film, luminance and luminance uniformity were evaluated, and the results thereof are listed in Table 2.

| | |
|---|---|
| Solvent | 41.4 parts by weight |
| (n-butylacetate, volume resistance of | |
| 2.08 × 10¹⁰ Ωcm) | |
| Binder resin | 25.4 parts by weight |
| (Acrydic AA-960-50, Aekyung Chemical, | |
| Korea, 55% solids) | |
| Curing agent | 2.9 parts by weight |
| (Burnock DN-950, Aekyung Chemical, | |
| Korea) | |
| Light diffuser | 30.3 parts by weight |
| (Techpolymer MBX-15, Sekisui Chemical | |
| Co., Ltd., Japan) | |

### EXAMPLE 2

A light diffusing composition having a volume resistance of 2×10⁹ Ωcm prepared at the following amounts, was used to manufacture a light diffusing film by the same apparatus and method as in Example 1. Occurrence of electrostatic spots on the surface of the light diffusing film, luminance and luminance uniformity were evaluated, and the results thereof are listed in Table 2.

| | |
|---|---|
| Solvent | 41.4 parts by weight |
| (MEK:Toluene = 1:1, volume resistance of | |
| 1.06 × 10⁹ Ωcm) | |
| Binder resin | 25.4 parts by weight |
| (Acrydic AA-960-50, Aekyung Chemical, Korea) | |
| Curing agent | 2.9 parts by weight |
| (Burnock DN-950, Aekyung Chemical, Korea) | |
| Light diffuser | 30.3 parts by weight |
| (Techpolymer MBX-15, Sekisui Chemical | |
| Co., Ltd., Japan) | |

### COMPARATIVE EXAMPLE 1

A light diffusing composition having a volume resistance of 6×10¹² Ωcm prepared at the following amounts, was used to manufacture a light diffusing film by the same apparatus and method as in Example 1. Occurrence of electrostatic spots on the surface of the light diffusing film, luminance and luminance uniformity were evaluated, and the results thereof are listed in Table 2.

| | |
|---|---|
| Solvent | 41.4 parts by weight |
| (Toluene, volume resistance of | |
| 1.29 × 10¹³ Ωcm) | |
| Binder resin | 25.4 parts by weight |
| (Acrydic AA-960-50, Aekyung Chemical, Korea) | |
| Curing agent | 2.9 parts by weight |
| (Burnock DN-950, Aekyung Chemical, Korea) | |
| Light diffuser | 30.3 parts by weight |
| (Techpolymer MBX-15, Sekisui Chemical | |
| Co., Ltd., Japan) | |

### COMPARATIVE EXAMPLE 2

A light diffusing composition having a volume resistance of 7.1×10¹³ Ωcm prepared at the following amounts, was used to manufacture a light diffusing film by the same apparatus and method as in Example 1. Occurrence of electrostatic spots on the surface of the light diffusing film, luminance and luminance uniformity were evaluated, and the results thereof are listed in Table 2.

| | |
|---|---|
| Solvent | 41.4 parts by weight |
| (Toluene:Xylene = 1:1, volume resistance of | |
| 2.08 × 10¹³ Ωcm) | |
| Binder resin | 25.4 parts by weight |
| (Acrydic DU-589, Aekyung Chemical, Korea, | |
| 55% solids) | |
| Curing agent | 2.9 parts by weight |
| (Burnock DN-950, Aekyung Chemical, Korea) | |
| Light diffuser | 30.3 parts by weight |
| (Techpolymer MBX-15, Sekisui Chemical | |
| Co., Ltd., Japan) | |

### EXPERIMENTAL EXAMPLE

### Preparation of Light Diffusing Films

The light diffusing compositions prepared in Examples 1 and 2 and Comparative Examples 1 and 2 were coated on a 100 μm thick PET film (Model No. SH71S of SKC Co., Ltd., Korea) using a gravure coating device at a dose of 14 gim′ at a coating speed of 20 m/min, and dried at 100 ° C., thereby manufacturing light diffusing films.

TABLE 2

| | | | | Comparative | Comparative |
|---|---|---|---|---|---|
| | | Example 1 | Example 2 | Example 1 | Example 2 |
| Solvent | | n-butylacetate | MEK:Toluene | Toluene | Toluene:Xylene |
| Solvent composition ratio | | — | 1:1 | — | 1:1 |
| Volume | Solvent | 2.1 × 10¹⁰ | 1.1 × 10⁹ | 1.3 × 10¹³ | 2.1 ×10¹³ |
| resistance | Composition | 4.0 × 10¹⁰ | 2.0 × 10⁹ | 6.0 × 10¹² | 7.1 × 10¹³ |

| | | | | |
|---|---|---|---|---|
| Electrostatic electricity | Not generated | Not generated | Generated | Generated |
| Average luminance | 1760 | 1758 | 1431 | 1524 |
| (Cd/m²) | | | | |
| Luminance uniformity | 75 | 73 | 50 | 48 |

<Evaluation>

Volume Resistance

The volume resistance of a light diffusing film was measured by a megohmmeter DSM-8103 available from Dongah Electric Co., Ltd. under the condition that a distance between electrodes was set to 1.9 cm at room temperature.

Electrostatic Spots

To evaluate coating irregularities shaped of a bird's foot or ellipse, which are also called electrostatic spots, the surfaces of dried light diffusing films were observed by naked eye.

Average Luminance and Luminance Uniformity

A light diffusing film was placed on a light guide plate of a liquid crystal backlighting unit and luminance was measured using a BM-7 tester available from TOPCON Co., Ltd. For luminance values measured at 10 arbitrary points, the maximum value was marked by Lₘₐₓ and the minimum value was marked by Lₘᵢₙ. Then, luminance uniformity was calculated by the formula 1. It was determined that the luminance uniformity was good when the calculation result was greater than 70%.

Luminance uniformity=(Lₘᵢₙ/Lₘₐₓ)×100 (%)

As understood from the results listed in Table 2, in Examples 1 and 2 of the present invention in which the volume resistance of an organic solvent was controlled such that the volume resistance of the light diffusing composition was not greater than 1×10¹³ Ωcm, electrostatic spots were not generated, while exhibiting good luminance and high luminance uniformity.

On the other hand, in Comparative Examples 1 and 2 in which the volume resistance of the light diffusing composition was greater than 1×10¹³ Ωcm, electrostatic spots were generated, luminance was deteriorated and luminance uniformity was poor, so that the light diffusing composition was disadvantageous to be applied to a variety of kinds of picture display devices.

### Industrial Applicability

In the composition for a light diffusing film according to the present invention, in which the volume resistance of an organic solvent used to control the volume resistance of the composition to be not greater than 1×10¹³ Ωcm, no electrostatic spots are generated, providing a clean appearance. Also, according to the present invention, since luminance characteristics are improved and luminance uniformity is enhanced, the light diffusing composition can be advantageously applied to a variety of kinds of picture display devices, in particular, in a display device employing liquid crystal display device (LCD) backlighting systems or light emitting diode (LED) lamps.

1. A composition for a light diffusing film, the composition comprising 100 parts by weight of a binder resin, 10 to 500 parts by weight of a light diffuser and 30 to 500 parts by weight of an organic solvent and having a volume resistance of 1×10¹³ Ωcm or less.

2. The composition according to claim 1, wherein the volume resistance of the organic solvent is 1×10¹³ Ωcm or less.

3. The composition according to claim 1, wherein the organic solvent is at least one selected from the group consisting of toluene, dichlorethane, methylethylketone (MEK), methylisobutylketone, cyclohexanone, ethylacetate, n-butylacetate, xylene, cyclohexane, tetrahydrofuran, n-heptane and cellusolvacetate, and has a volume resistance of less than or equal to 5×10¹² Ωcm.

4. The composition according to claim 1, wherein the binder resin is at least one selected from the group consisting of polyvinylalcohol, ethylene vinyl copolymer, acryl-based resin, polyester-based resin, styrene-based resin, alkyd-based resin, arnino-based resin, polyurethane-based resin and epoxy-based resin.

5. The composition according to claim 1, wherein the light diffuser is either an inorganic or organic light diffuser.

6. The composition according to claim 5, wherein the inorganic light diffuser is silica, zirconia, calcium carbonate, barium sulfonate or titanium oxide.

7. The composition according to claim 5, wherein the organic light diffuser is a homopolymer or copolymer obtained from propylene, vinylidene chloride, acrylonitrile, methyl(meth)acrylate, styrene and urethane.

8. The composition according to claim 1, further comprising each 0.1 to 10 parts by weight of a curing agent, a static electricity resisting agent, a leveling agent and a wetting agent, based on 100 parts by weight of the binder resin.

9. A light diffusing film obtained by coating the composition according to claim 1.

10. A liquid crystal display device (LCD) backlighting system employing the light diffusing film according to claim 9.
